(19) United States
(12) Patent Application Publication
(10) Pub. No.: US 2008/0172393 A1
(43) Pub. Date: Jul. 17, 2008

(54) System and Method for Public Access and Control of MLS Data

(76) Inventor: Glen L. Baird, Fairfax, VA (US)

Correspondence Address: WHITE-WELKER & WELKER, LLC, P.O. BOX 199, CLEAR SPRING, MD, 21722-0199, US

(21) Appl. No.: 11/623,126

(22) Filed: Jan. 15, 2007

(51) Int. Cl. G06F 17/30

(52) U.S. Cl. 707/10; 707/E17.001

(57) ABSTRACT

A system that allows unlicensed and/or non-members of the local MLS to remotely submit listing data to the data entry side of the local MLS(s). Members, through a Remote Internet Database Manager (RIDM), can add and modify listings in the Local MLS Database. An exporter module distributes data contained in the RIDM to the Local MLS Database through an Export Filter. An export filter scans text fields for prohibited or questionable words. An importer module distributes data in the Local MLS Database to the RIDM through an Import Filter. Listings in the Local MLS Database are imported to the RIDM through an Import Filter. The Import Filter compares the Local MLS Database listings to the listing already contained in the RIDM. RIDM listings can be manually or automatically selected for export to the Local MLS Database. RIDM listings can be selected to be updated in three different modes: a first mode provides Updates from the MLS; a second mode provides Updates from RIDM and the Local MLS Database; and a third mode provides Updates from the RIDM.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention relates generally to a computer program and method for accessing a Real Estate Multiple Listing Service (MLS) system. More specifically the present invention relates to a software system that allows unlicensed and/or non-members of the local MLS to remotely submit listing data to the data entry side of the local MLS(s) through a website membership.

### BACKGROUND OF THE INVENTION

Many antiquated marketing techniques are currently in use for residential real estate sales including: Newspaper Ads, Specialty Real Estate Publications, Static WebPages, Direct Mail, Directional Signs, Sign Post, telemarketing and many others.

The most powerful marketing tool available to sell real estate is the local Multiply Listing Service (MLS). To access the data input side of the local MLS one must be a member of the local MLS. To become a member one must hold a real estate brokers license or sales person real estate license. Obtaining a brokers licenses can require years of experience, college level courses, minimum statutory state exam requirements, business license, office space, insurance, and other incidental business requirements. Obtaining a sales persons license can require months of training, minimum statutory state exam requirements, insurance, incidental business requirements, and required affiliation with a real estate broker.

Through the use of technology, property listings placed in the MLS are propagated across the Internet. Real estate offices, county and state agencies, appraisers, private real estate service companies, newspaper publishers, and private listing propagators all pull the MLS data for private use or redistribution.

For example US Patent Application Publication 20040138912 for a Multiple listing services (MLS) data redistribution teaches computer databases of “For Sale” listings of residential real estate properties aggregated by MLSs are retrieved electronically as frequently as daily from the MLSs and compared on a daily basis with the databases of residential property customer records uploaded by subscribers. To the extent that such comparisons identify matching residential properties from both databases, such matches are reported daily to mortgage brokers or lenders whose customer properties were matched.

Many websites display the static MLS information and may add other services related to the address and geographic location. Some websites offer demographics and mapping of the property based on postal address and links to school districting information based on the schools in the listing. Even more websites offer some type of searching feature. For example, U.S. Pat. No. 6,519,618 issued to Snyder for discloses a method of searching a plurality of MLS databases including accessing a plurality of MLS databases, resolving an array of schemas from the plurality of MLS databases, establishing a first array of common fields from the array of schemas, establishing a second array of distinct fields from the array of schemas, displaying a search query interface including the first array of common fields and the second array of distinct fields, selecting a root database from the plurality of MLS databases, selecting at least one child database from the plurality of MLS databases, and returning a search query against the root database wherein data from the at least one child database is only included for common fields selected in the search query interface.

Currently some local MLS's are offering their members the ability to upload photos, maps, plats, floor plans, and links to outside website URL's. More typically, unlicensed property owners and/or non-members of the local MLS are barred from accessing the data entry side of the local MLS preventing them from: adding and editing property listings, uploading photos, maps, plats, floor plans or other property information to the MLS.

For example US Patent Publication 20050091218 discloses a system and process for capturing all regionally supported data regarding a real estate property for sale, and a system and process for loading that captured data to a regional multiple listing database system, using a portable computing device is detailed. A general purpose portable computing device (such as the Palm OS personal data assistant PCD, or the handheld Microsoft Pocket PC, HPC) is capable of running custom software applications for the collection and display of information and can be configured to store collected information in persistent storage, for later retrieval and manipulation, on the portable computing device. A regional multiple listing service maintains a database and search engine of all properties listed for sale in a specific geographic region, and which are listed for sale with a licensed real estate agent. This system provides a software application on the portable computing device that allows the real estate agent to collect all the necessary data, while in the field, to create a listing entry in the multiple listing database. The system is configured such that the field collected data can be automatically published to the multiple listing database at the next opportunity the real estate agent has to synchronize the portable computing device with an Internet connected computer. The system is also configured to correct common data collection mistakes made by a plurality of real estate agents, and also correct common mistakes made while transcribing the data into the multiple listing database. Again, the major shortcoming is that one must be a real estate agent to access and use the MLS system and interact with it in the manner disclosed.

The present invention was created as a solution to the problems commonly associated with enabling non-members with the ability to upload and edit text, photos, maps, plats, floor plans, links, etc. for their listing in an MLS database.

### SUMMARY OF THE INVENTION

In accordance with the present an organization system is provided which overcomes the aforementioned problems of the prior art. The present invention is a software system that allows unlicensed and/or non-members of the local MLS to remotely submit listing data to the data entry side of the local MLS(s) through a website membership.

Members, through a Remote Internet Database Manager (RIDM), can add and modify listing in the MLS including data, photos, plats, surveys, floor plans, outside website URL's and other related information. The information submitted or modified is filtered for proper information including: federal, state, and local statutory requirements, local MLS requirements, fair housing compliancy, and data structure.

Property owners must become a Member before access is granted to the RIDM. Property owners must complete a registration process through their confirmed email address to become a Member. Upon a property owner becoming a Member of the Remote Internet Database Manager the owner may submit a property listing(s) to the database. The step-by-step process has mandatory fields for the RIDM and the MLS. All steps and mandatory items must be completed. Property Listings can be manually selected or automatically selected for export to the MLS. Members can select and deselect property listing for inclusion to a RSS feed. An administrator can override the Member's selection statuses.

An exporter module distributes data contained in the RIDM to the MLS through an Export Filter. Data of only selected listings is exported to the MLS. Only completed property listing can be selected for export to the MLS. If a property listing is selected the property listing is export to the RIDM export filter. The export filter compares listing data in the RIDM and the local MLS. The most current data is transferred to the MLS by comparing last modified date stamps and metadata. The export filter scans text fields for prohibited or questionable words. If a listing is found to have a prohibited or questionable word the listing is automatically deselected and the listing is sent to the administrator to edit, override and reselect for export. Only changes to text fields trigger the scan feature of the exporter. All changes to non-text fields are automatically selected to be exported to the MLS.

An importer module distributes data in the Local MLS Database to the RIDM through an Import Filter. Listings in the MLS are imported to the RIDM through an Import Filter. The Import Filter compares the MLS listings to the listing already contained in the RIDM. The most current data is transferred to the RIDM by comparing last modified date stamps and metadata. RIDM listing can be selected to be updated in three different modes.

A first mode provides Updates from the MLS. All information is updated from the MLS, except RIDM Exclusive Added Information. Other than RIDM Exclusive Added Information no other RIDM changes are permitted. MLS virtual tours may overwrite RIDM virtual tours.

A second mode provides Updates from RIDM and MLS. Changes are permitted from both the RIDM and the MLS. All Information is updated from the MLS except RIDM Exclusive Added Information and RIDM based changes can modify all data including RIDM Exclusive Added Information.

A third mode provides Updates from RIDM only. All information is updated from the RIDM only, including RIDM Exclusive Added Information. No information is imported from the MLS.

A fourth mode provides that listings may not be exported or imported from the Local MLS Database, they can only be input to the RIDM. If an administrator selects no export, then the export types described in the first, second, and third modes do not apply.

RIDM Exclusive Added Information in Each Property Listing includes: Aerial Photos; Enhanced location; Geo-coding; assigning a Longitude and Latitude coordinate to a street location; RIDM Submitted Computer Images; Photos, floor plans, plats and other images; Virtual Tour Links other than MLS virtual tour; and Links to Outside URLs such as Custom Seller Pages, and Builder Corporate Sites.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flow chart illustrating the system of the present invention;

FIG. 2 illustrates the physical layout of the present invention;

FIG. 3 is a flow chart illustrating the RIDM Data Export Process of the present invention;

FIG. 4 is a flow chart illustrating the RIDM Data Import Process of the present invention;

FIG. 5 is a screen shot of the member login and GUI of the present invention;

FIG. 6 is a partial screen shot of the listing information required to be entered by a user;

FIG. 7 is a screen shot of the Property Information Submission Form used by the present invention to enable a user to add and edit property information;

FIG. 8 is a screen shot of the image uploading page of the present invention; and

FIG. 9 is a screen shot of a representative Virginia MLS Listing Administration screen.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

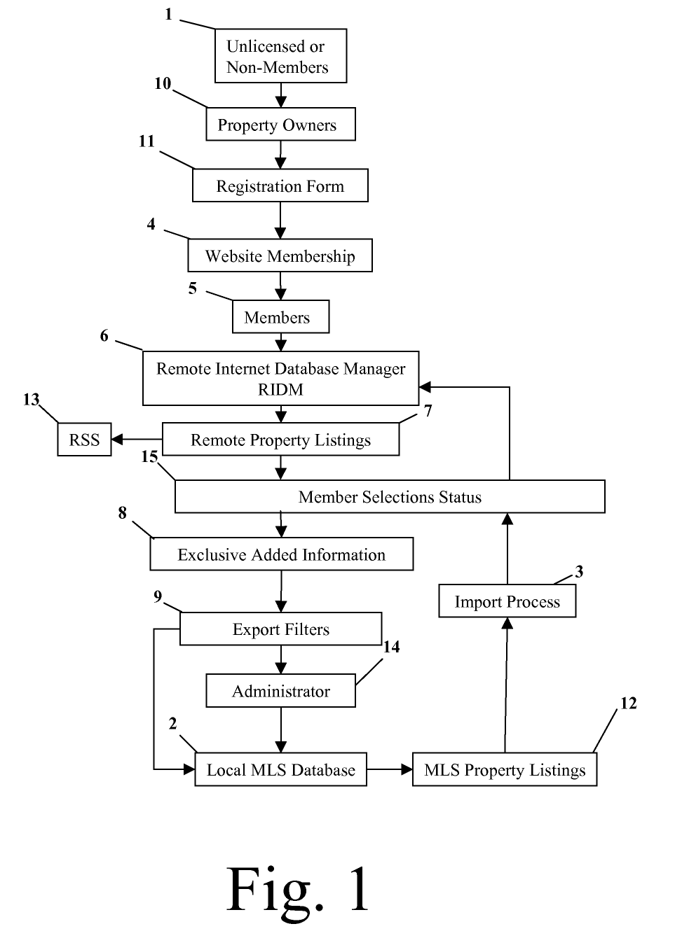

Now referring to FIG. 1 a flow chart illustrates the system of the present invention. The present invention allows Unlicensed and/or Non-Members 1 of the Local MLS Database 2 to remotely submit listing data to the data entry side of the Local MLS Database 2 through a Website Membership 4. Members 5, through a Remote Internet Database Manager (RIDM) 6 can add and modify Remote Property Listings 7 for export to the Local MLS Database 2. Property Owners 10 must become a Member 5 before access is granted to the RIDM 6. Property Owners 10 must complete a Registration process 11 through their confirmed email address to become a Member 5. Upon a Property Owner 10 becoming a Member 5 of the Remote Internet Database Manager 6 the Property Owner 10 may submit Remote Property Listing(s) 7 to the Local MLS Database 2. Members 5 can upload to the Remote Property Listings 7: photos, plats, surveys, floor plans, and submit outside website URL's and other related Exclusive Added Information 8. The information and data submitted or modified is scanned by the Export Filters 9 for proper information including: federal, state, and local statutory requirements, local MLS requirements, fair housing compliancy, and data structure.

A step-by-step process has mandatory fields for the RIDM 6 and the Local MLS Database 2. All steps and mandatory items must be completed. Remote Property Listings 7 can be manually selected or automatically selected for export to the Local MLS Database 2 via the Member Selection Status 15. Members 5 can select and deselect Remote Property Listing 7 for inclusion to a RSS feed 13. An administrator 14 can override the Member Selection Status 15 and RSS feed 13.

New and updated MLS Property Listings 12 from the Local MLS Database 2 are imported to the RIDM 6 through the Import Process 3 depending on the Member Selection Status 15.

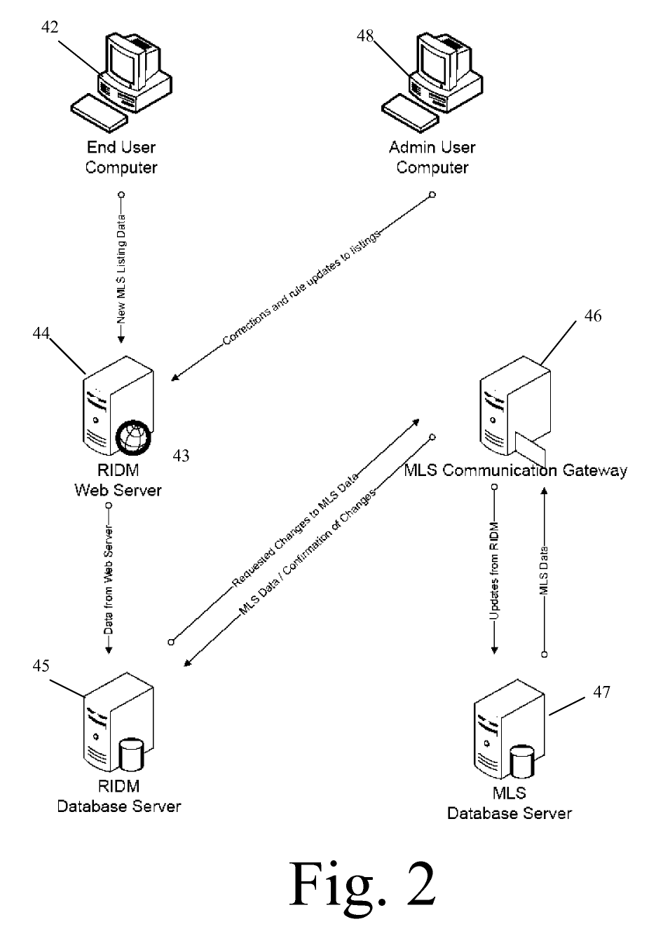

FIG. 2 illustrates the physical layout of the present invention. An end user computer 42 is used to submit Remote Property Listings 7 or Exclusive Added Information 8 via a multi-user network such as the Internet 43 to the RIDM Web server 44. Data from the RIDM Web server 44 is then transmitted to the RIDM Database Server 45 where the requested changes to the Local MLS Database are sent to the MLS Communication Gateway 46 and then transferred to the MLS Database Server 47. Once the MLS Communication Gateway 46 has successfully completed the transmission a confirmation of the changes and the new MLS data is sent to the RIDM Database Server 45. An administrative user can use a separate computer 48 to access the RIDM Web Server 44 in the same manner previously described for an end use, but has the additional functionality for making any corrections to Remote Property Listings 7, Exclusive Added Information 8, or changing or updating the rules and requirements for Remote Property Listings 7 and Exclusive Added Information 8.

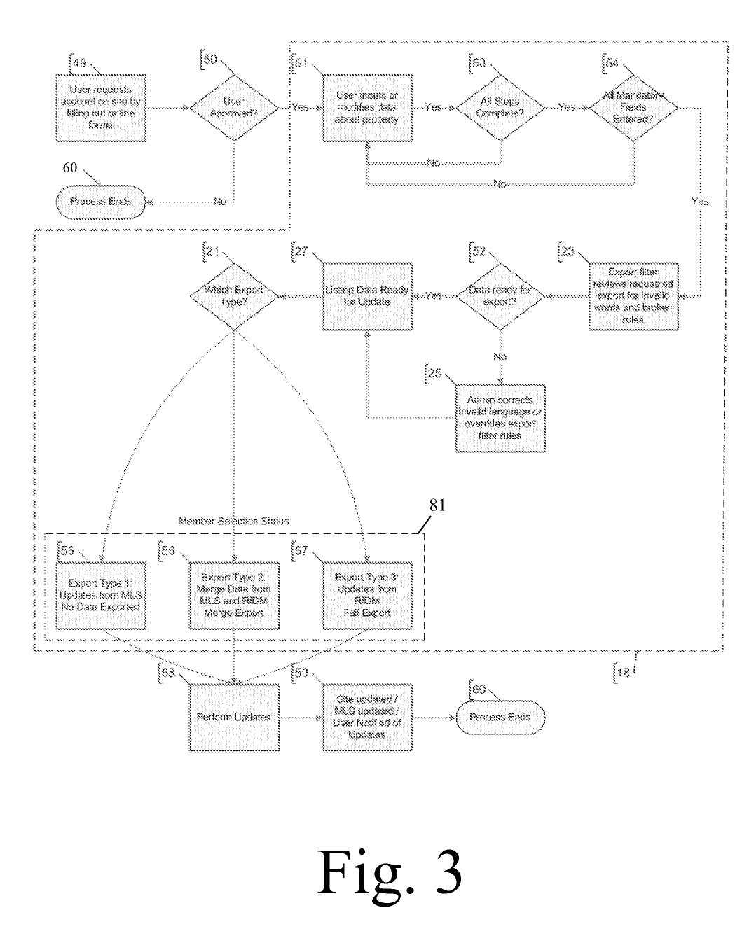

Now referring to FIG. 3, an exporter module distributes data contained in the RIDM 6 to the Local MLS Database 2 through an Export Filter. Data of only selected listings is exported to the Local MLS Database 2. A user must have an account 49 and be approved 50 by the system or the process is terminated. Only completed property listings can be selected for export to the Local MLS Database 2. A user may input or modify property data 51 of the selected property. All required steps 53 and mandatory fields 54 must be completed or the user is prompted to input or modify the information or data about the selected property. Once all required data has been entered, the exporter compares listing data 7 in the RIDM 6 and the Local MLS Database 2. The most current listing data is transferred to the Local MLS Database 2 by comparing last modified date stamps and metadata.

The export filter scans text fields for prohibited or questionable words 23 to determine if the data is ready for export 52. If a listing 7 is found to have a prohibited or questionable wording the listing is automatically deselected and the listing is sent to the administrator to edit, override and reselect for export. Only changes to text fields trigger the export filter 23 of the exporter 18. All changes to non-text fields are automatically selected to be exported 27 to the Local MLS Database 2. An export type 21 set by the Unlicensed or Non-Member 1 is determined. Member selection 81 allows one of three export updates to be selected. A first export type 55 updates from only the Local MLS Database 2, a second export type 56 merges data from the Local MLS Database 2 and the RIDM 6, and a third export type 57 updates the Local MLS Database 2 from only the RIDM. Once the export is performed 58 the updates are completed and the user is notified of the updates 59 and the process ends 60.

In the first export type 55 No Export, all information is updated from the Local MLS Database 2, except RIDM Exclusive Added Information 8. Other than RIDM Exclusive Added Information 8 no other RIDM 6 changes are permitted, resulting in limited data control. MLS virtual tours may overwrite RIDM virtual tours.

In the second export type 56 full data control and full export and import, changes are permitted from both the RIDM 6 and the Local MLS Database 2 creating a full merge of data. Information is updated from Local MLS Database 2 with the exception of RIDM 2 Exclusive Added Information 8. The RIDM 6 based changes can modify all data including RIDM 6 Exclusive Added Information 8.

A the third export type 57 full data control and full export, no import, all information is updated from the RIDM 6 only, including RIDM Exclusive Added Information 8. No information is imported from the Local MLS Database 2. This results in Internet only data control functionality.

A fourth mode provides that listings may not be exported or imported from the Local MLS Database, they can only be input to the RIDM. If an administrator selects no export, then the export types described in the first, second, and third modes do not apply.

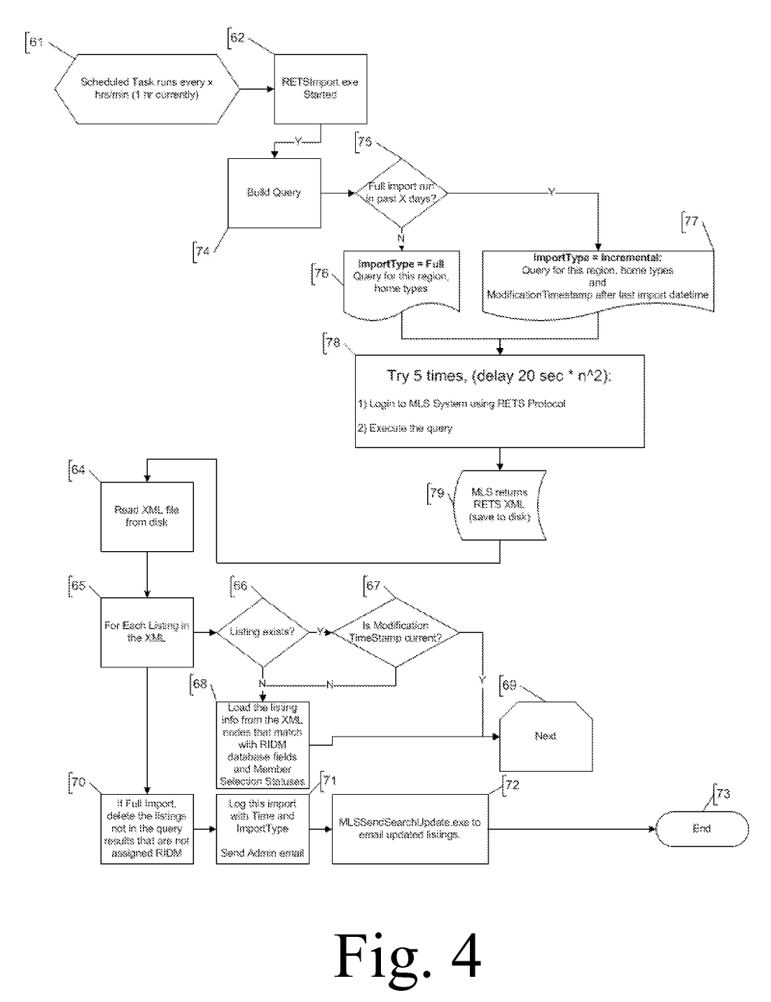

Now referring to FIG. 4, the RIDM 6 data import process is illustrated. The RIDM Data Import process is scheduled to run at preset intervals 61 and in a best mode runs every hour, but can be changed on a minute or hourly increment. When scheduled to run the RETSimport.exe program is launched 62. A query is built 74 and the system determines if full import has been run in the past 75, full imports may be scheduled to run at preset intervals hours or days. If no full import has been run in the past 75, then the import type is a full import 76, but if an import has recently been run, then only an incremental import 77 will occur for property listings. The importer will login to the MLS system using a RETS protocol and execute the query 78. Upon successful execution the MLS will return a RETS XML file which is saved to file 79 and the process continues with the program reading the XLM file 64 for each listing in the XML 65. If this listing exists 66 the time stamp is check to determine if the modification is current 67. If the listing does not exists or the modification is not current the importer will only load the listing information from the XML nodes that matches with RIDM database fields 68 and member selection status 81. This process will then repeat 69 for each property listing. The import is logged with time and import type information and an email is sent to the administrator 71. An MLSSendSearchUpdate.exe program is launched to email the updated listings as desired 72 and the process ends 73. If a full import 70, a deletion of the listing not in the query results that are not assigned in the RIDM occurs.

RIDM 6 Exclusive Added Information 8 in Each Property Listing 7 may include but is not limited to aerial photos, URLs links to Custom Seller Pages, Virtual Tour Links and Builder Corporate Sites, enhanced location geo-coding (Assigning a Longitude and Latitude coordinate to a street location). RIDM Submitted Computer Images may include but are not limited to photos, floor plans, plats and other images.

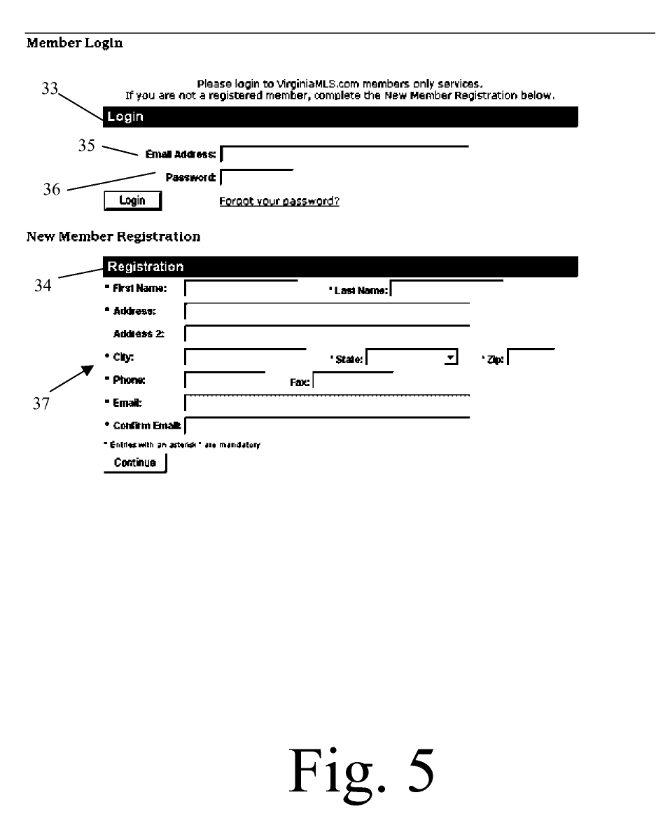

Now referring to FIG. 5 a screen shot of the graphical user interface of the website embodiment of the present invention illustrates the login 33 and registration areas 34. Any registered member 5 can simply login with a username 35 and password 36. Property owners who have not yet registered must complete and submit their information 37 to register and establish an account and generate a listing agreement 38.

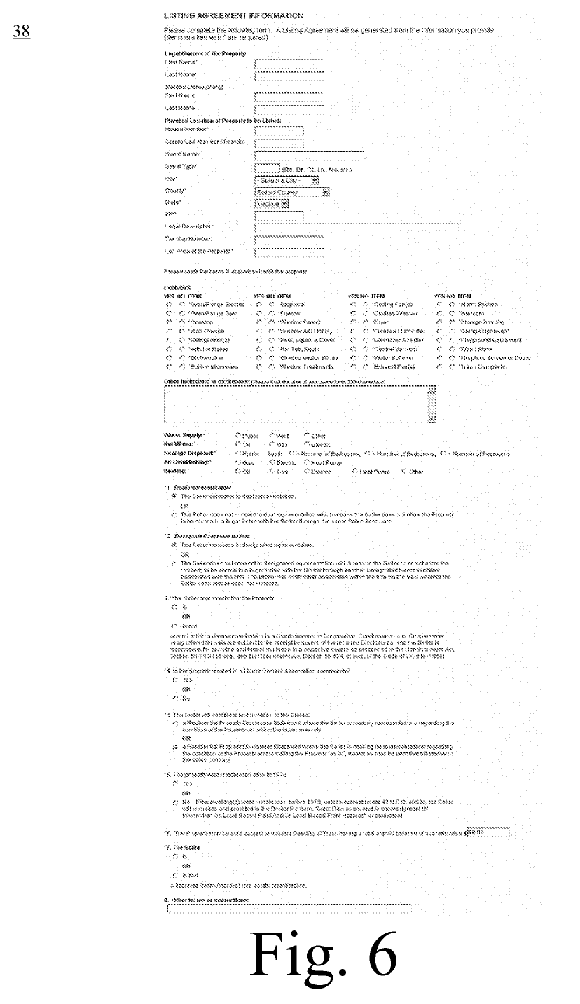

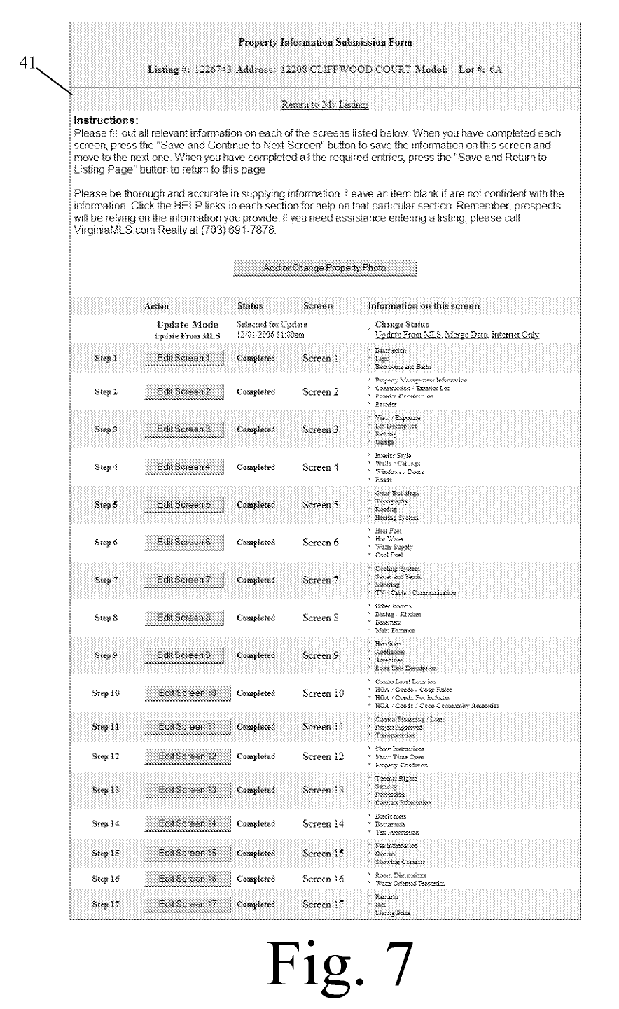

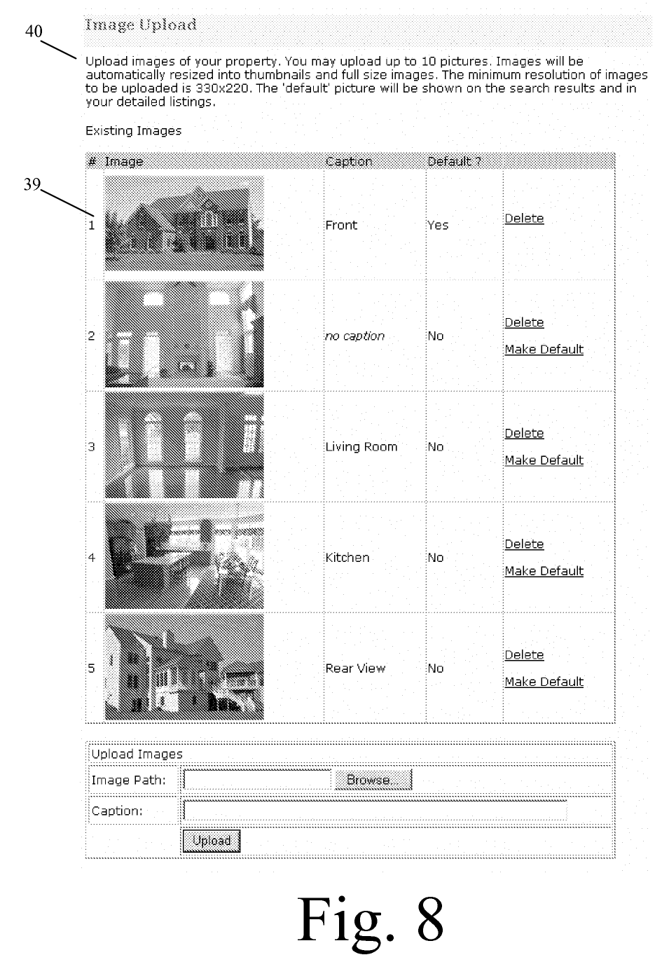

Upon agreeing to the terms of the Listing Agreement 38, as illustrated in FIG. 6, a database wizard will collect the features and details of a property and create a property information submission form 41 shown in FIG. 7. Upon completion of the database wizard and property information submission form 41, the member 5 has the option to upload and edit a plurality of their own digital photos 39, floor plans, and surveys using via the Image Upload page 40 illustrated in FIG. 8.

After completing the property information submission form 41 illustrated in FIG. 7 and uploading photos 39 as shown in FIG. 8, the system automatically submits the property information based on the member selection status to the Local MLS Database 2 for distribution to all participating Brokers and Agents.

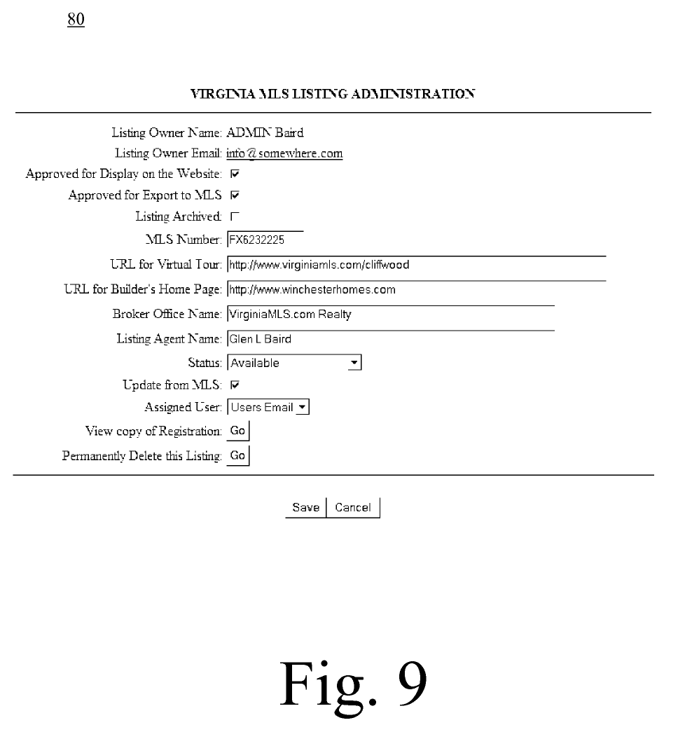

Now referring to FIG. 9, a representative Virginia MLS Listing Administration screen shot 80 is shown. The Virginia MLS Listing Administration screen 80 includes Remote Property Listing information: listing owner, links, and registration information. The Virginia MLS Listing Administration screen allows the administrator to approve/disapprove: property listing display on the Internet website, export to the Local MLS Database, and Updating from the Local MLS Database.

It is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A system recorded on computer-readable medium and capable of execution by a computer for allowing unlicensed or non-members of the local MLS to remotely submit listing data to the data entry side of the local MLSs through a website membership whereby:
members, through a Remote Internet Database Manager, can add and modify listing in the MLS;
members can upload information to the MLS;
property owners must become a Member before access is granted to the Remote Internet Database Manager;
upon a property owner becoming a Member of the Remote Internet Database Manager the owner may submit property listings to the MLS database; and
property listings can be manually selected or automatically selected for export to the MLS.

2. The system recorded on computer-readable medium and capable of execution by a computer for allowing unlicensed or non-members of the local MLS to remotely submit listing data to the data entry side of the local MLSs through a website membership of claim 1 wherein the information uploaded includes photos, plats, surveys, floor plans, and outside website URL's.

3. The system recorded on computer-readable medium and capable of execution by a computer for allowing unlicensed or non-members of the local MLS to remotely submit listing data to the data entry side of the local MLSs through a website membership of claim 1 wherein
the information submitted or modified is filtered for proper information including: federal, state, and local statutory requirements, local MLS requirements, fair housing compliancy, and data structure.

4. The system recorded on computer-readable medium and capable of execution by a computer for allowing unlicensed or non-members of the local MLS to remotely submit listing data to the data entry side of the local MLSs through a website membership of claim 1 wherein
a step-by-step process has mandatory fields for the Remote Internet Database Manager and the MLS and all steps and mandatory items must be completed before a member of the Remote Internet Database Manager may submit property listings to the MLS database.

5. The system recorded on computer-readable medium and capable of execution by a computer for allowing unlicensed or non-members of the local MLS to remotely submit listing data to the data entry side of the local MLSs through a website membership of claim 1 wherein
Members can select and deselect property listing for inclusion to a RSS feed.

6. The system recorded on computer-readable medium and capable of execution by a computer for allowing unlicensed or non-members of the local MLS to remotely submit listing data to the data entry side of the local MLSs through a website membership of claim 1 wherein
an administrator can override the Member's selection statuses.

7. The system recorded on computer-readable medium and capable of execution by a computer for allowing unlicensed or non-members of the local MLS to remotely submit listing data to the data entry side of the local MLSs through a website membership of claim 1 further comprising an exporter module that distributes data contained in the Remote Internet Database Manager to the Local MLS Database through an Export Filter.

8. The system recorded on computer-readable medium and capable of execution by a computer for allowing unlicensed or non-members of the local MLS to remotely submit listing data to the data entry side of the local MLSs through a website membership of claim 7 wherein
data of only selected listings is exported to the MLS;
only completed property listing can be selected for export to the MLS;
a selected property listing is export to the Remote Internet Database Manager export filter;
the export filter compares listing data in the Remote Internet Database Manager and the local MLS;
the most current data is transferred to the MLS by comparing date stamps, images and metadata; and
the export filter scans text fields for prohibited or questionable words.

9. The system recorded on computer-readable medium and capable of execution by a computer for allowing unlicensed or non-members of the local MLS to remotely submit listing data to the data entry side of the local MLSs through a website membership of claim 8 wherein only changes to text fields trigger the scan feature of the export module.

10. The system recorded on computer-readable medium and capable of execution by a computer for allowing unlicensed or non-members of the local MLS to remotely submit listing data to the data entry side of the local MLSs through a website membership of claim 8 wherein all changes to non-text fields are automatically selected to be exported to the MLS.

11. The system recorded on computer-readable medium and capable of execution by a computer for allowing unlicensed or non-members of the local MLS to remotely submit listing data to the data entry side of the local MLS(s) through a website membership of claim 1 further comprising an importer module that
distributes data in the MLS to the Remote Internet Database Manager through an Import Filter;
listings in the MLS are imported to the Remote Internet Database Manager through the Import Filter;
the Import Filter compares the MLS listings to the listing already contained in the RIDM.

12. The system recorded on computer-readable medium and capable of execution by a computer for allowing unlicensed or non-members of the local MLS to remotely submit listing data to the data entry side of the local MLS(s) through a website membership of claim 11 wherein Remote Internet Database Manager listings and local MLS listings can be selected to be updated in three different modes.

13. The system recorded on computer-readable medium and capable of execution by a computer for allowing unlicensed or non-members of the local MLS to remotely submit listing data to the data entry side of the local MLS(s) through a website membership of claim 12 wherein a first mode provides
updates from the MLS;
all information is updated from the MLS, except Remote Internet Database Manager Exclusive Added Information;
other than Remote Internet Database Manager Exclusive Added Information no other Remote Internet Database Manager changes are permitted; and
MLS virtual tours may overwrite Remote Internet Database Manager virtual tours.

14. The system recorded on computer-readable medium and capable of execution by a computer for allowing unlicensed or non-members of the local MLS to remotely submit listing data to the data entry side of the local MLS(s) through a website membership of claim 11 wherein a second mode provides
updates from Remote Internet Database Manager and Local MLS Database;
changes are permitted from both the Remote Internet Database Manager and the Local MLS Database;
all Information is updated from the MLS except Remote Internet Database Manager Exclusive Added Information; and
RIDM based changes can modify all data including Remote Internet Database Manager Exclusive Added Information.

15. The system recorded on computer-readable medium and capable of execution by a computer for allowing unlicensed or non-members of the local MLS to remotely submit listing data to the data entry side of the local MLS(s) through a website membership of claim 11 wherein a third mode provides
updates from Remote Internet Database Manager only;
all information is updated from the Remote Internet Database Manager only, including Remote Internet Database Manager Exclusive Added Information; and
no information is imported from the MLS.

16. The system recorded on computer-readable medium and capable of execution by a computer for allowing unlicensed or non-members of the local MLS to remotely submit listing data to the data entry side of the local MLS(s) through a website membership of claim 15 wherein Remote Internet Database Manager Exclusive Added Information in Each Property Listing includes: Aerial Photos; Enhanced location; Geo-coding; assigning a Longitude and Latitude coordinate to a street location; Remote Internet Database Manager Submitted Computer Images; Photos, floor plans, plats, images; Virtual Tour Links other than MLS virtual tour; and Links to Outside URLs.

17. The system recorded on computer-readable medium and capable of execution by a computer for allowing unlicensed or non-members of the local MLS to remotely submit listing data to the data entry side of the local MLSs through a website membership of claim 8 wherein any imported listing contained in the local MLSs may be assigned and edited by the Remote Internet Database Manager.
